(19) United States
(12) Patent Application Publication
(10) Pub. No.: US 2009/0006977 A1
(43) Pub. Date: Jan. 1, 2009

(54) Method and System of Computer Remote Control that Optimized for Low Bandwidth Network and Low Level Personal Communication Terminal Device

(76) Inventor: Jae Bum Shim, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 11/995,298

(22) PCT Filed: May 3, 2006
(86) PCT No.: PCT/KR2006/001663

§ 371 Date: Jul. 15, 2008

(30) Foreign Application Priority Data
Jul. 11, 2005 (KR) 10-2005-0062380

(51) Int. Cl. G06F 15/16; G06F 3/00

(52) U.S. Cl. 715/740

(57) ABSTRACT

Provided is a method and system for controlling a remote computer. In order to remotely control the remote computer, a communication terminal requests attribute information of an application program installed in the remote computer through a communication network. Then, the remote computer transmits attribute information by extracting the attribute information of the application program and processing the extracted attribute information. The remote communication terminal receives the attribute information, and reconstructs a user interface of the application program on the basis of the received information.

### TECHNICAL FIELD

The present invention relates to a method and system for controlling a remote computer, more particularly, to a method for controlling a remote computer and a system using the same to directly control the remote computer and execute an application program thereof with a low-performance remote communication terminal through a wired or wireless low-speed network environment.

### BACKGROUND ART

Between a remote computer located at a remote location and a user computer or between the remote computer and a personal communication terminal, data synchronization may be established through a wired or wireless network. Generally, the data synchronization has been made by capturing an image of a graphic user interface displayed at the remote computer, compressing the captured image, and transmitting the captured image, or by capturing graphics device interface (GDI) and synchronizing events. Since such a conventional method for data synchronization requires the enormous amount of data transmission, the data synchronization was expensive and d difficult to control in real-time under a low-speed communication environment such as low-speed MODEM communication or wireless mobile communication, whereas it caused no problem in a high speed communication network such as a local area network (LAN).

FIG. 1 is a block diagram for describing a method of controlling a remote computer in accordance with the related art. Referring to FIG. 1, a remote computer 10 which is the target of the remote control, a remote communication terminal 20, and a server 30 are communicably connected through a wired network. A user remotely controls the remote computer 10 through the remote communication terminal 20, for example, using a method of capturing the displayed graphic user interface of remote computer 10.

If the remote communication terminal 20 is not a typical computer but a personal digital assistant (PDA) or a mobile communication terminal of which screen size is smaller than that of the remote computer 10, and the image displayed on the screen of the remote computer 10 is transmitted intact to the remote communication terminal 20 by capturing the image and performing data synchronization on the captured image, the remote communication terminals 20 must scale down the image. Due to the downscaling, some of data may not be shown. Therefore, the user has many difficulties to control the remote computer. In general, since the PDA or wireless mobile communication terminal has a central processing unit (CPU) having lower performance than that of the typical computer, images are compressed in a joint photographic experts group (JPEG) format in order to reduce the amount of data transmission. Due to the lower performance of the remote communication terminal 20, the remote communication terminal 20 takes a relatively long time to decompress the compressed image. Therefore, it is very difficult to reflect the image changing of the remote computer 10 in real time.

Table 1 shows differences in a screen size and performance between a CPU of a typical computer and a CPU of a personal communication terminal such as a PDA or a mobile communication terminal.

TABLE 1

| Type | Screen Size | CPU |
|---|---|---|
| Computer | 640 × 480 800 × 600 | Pentium-III 800 MHz to Pentium- |
| | 1024 × 768 1280 × 1024 | IV 3 GHz |
| PDA | 240 × 320 | ARM9 200 MHz |
| Portable | 120 × 160 128 × 176 | ARM7 25 MHz to 50 MHz ARM9 |
| phone | 320 × 240 | 75 MHz to 120 MHz |

As shown in Table 1, the typical computer and the personal communication terminal have large differences in the screen size and the performance of their CPUs. Furthermore, the personal communication terminal such as a portable phone or a PDA has a simple input unit. Accordingly, it is not easy to bi-directionally control the remote computer that is controlled through a mouse or a keyboard. Therefore, the conventional method for controlling the remote computer is not suitable to be applied to a low-performance remote communication terminal.

### DISCLOSURE OF INVENTION

### Technical Problem

It is, therefore, an object of the present invention to provide a method for controlling a remote computer and a system using the same, which allow a user to control the remote computer by accessing the remote computer at a remote location and selecting one of task lists and functions of the remote computer even under a low-speed network environment.

It is another object of the present invention to provide a method for controlling a remote computer and a system using the same, which support optimized data synchronization to smoothly connect a high performance remote computer and a low performance remote communication terminal.

It is still another object of the present invention to provide a method for controlling a remote computer and a system using the same, which provide various user interface methods to smoothly control the remote computer, manage application programs, and search the Internet through the remote computer by overcoming differences in a screen resolution and an input unit of a high performance remote computer and a low performance remote communication terminal.

### Technical Solution

Accordingly, an aspect of the present invention is to solve at least the problems and disadvantages of the background art. In accordance with an aspect of the present invention, a method for controlling a remote computer includes requesting attribute information of an application program installed in the remote computer which is located at a remote location and connected to a communication network, receiving information through the communication network, wherein the information is created by extracting the attribute information of the application program and processing the extracted attribute information at the remote computer through, and reconstructing a user interface of the application program on the basis of the received information at a remote communication terminal.

The received information may include at least one of window coordinate information for the application program, graphic user interface (GUI) control information used within the application program, and image capturing information for the application program. The image capturing information for the application program may be information that is captured only a predetermined portion of an image of the application program if a screen resolution of the remote communication terminal is lower than that of the remote computer.

The window of the application program may be expressed in a frame format.

The method may further include requesting to modify the attribute information of the application program, and modifying the attribute information of the application program in response to the request and reporting the modified result at the remote computer. Also, the method may further include controlling an input device to be correspondent to an input unit of the remote computer at the remote communication terminal.

The received information may be regulated in a predetermined format to be correspondent to a transmit rate of the communication network. In the reconstructing of the user interface, the received information may be expressed by reconstructing coordinates to be correspondent to a screen size of the remote communication terminal. The method may further include receiving icon information of the remote computer and displaying the received icon information at the remote communication terminal, and driving the application program of the remote computer corresponding to selected icons from the displayed icon information.

In accordance with another aspect of the present invention, a system for controlling a remote computer includes a remote computer manager and a remote communication terminal. The remote computer manager extracts and processes attribute information of an application program installed in the remote computer and transmits the processed information through a communication network. The remote communication terminal requests the attribute information of the application program and reconstructs a user interface of the application program on the basis of the transmitted information from the remote computer.

The remote computer manager may be included in the remote computer. The remote computer and the remote communication terminal may communicate with each other directly through the communication network.

### ADVANTAGEOUS EFFECTS

A method for controlling a remote computer and a system using the same according to the present invention support optimized data synchronization between a relatively low performance remote communication terminal and a remote computer even in a low-speed communication network. Therefore, a user is allowed to effectively drive a target application program, search documents and check e-mails by accessing the computer in an office or home from anyplace where a communication network is available. Furthermore, the method for controlling a remote computer and the system using the same according to the present invention may be applicable to a thin client.

Especially, an e-mail can be checked from a remote location using a remote communication terminal according to the present invention. Also, a user is allowed to see a desired portion of data in a predetermined application program of a remote computer in a text format through a small screen of a remote communication terminal according to the present invention. Furthermore, since required information can be obtained without data loss, the method for controlling a remote computer and the system using the same according to the present invention can be used for business and personal. That is, the practical range thereof is much wider.

A method and system according to the present invention can control a remote computer and search information with a low cost because data can be transmitted twice faster than a conventional method even in a low-speed communication network. Therefore, greater economic benefits can be provided.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram for describing a method of controlling a remote computer in accordance with the related art;

FIG. 2 is a block diagram illustrating a system employing a method of controlling a remote computer in accordance with an exemplary embodiment of the present invention;

FIG. 3 is a message sequence chart for describing a process of extracting and processing attribute information of an application program of a remote computer;

FIG. 4 is a message sequence chart for describing a process of controlling a remote computer with a virtual mouse; and

FIG. 5 is a message sequence chart for describing a process of executing an application program of a remote computer with a remote communication terminal.

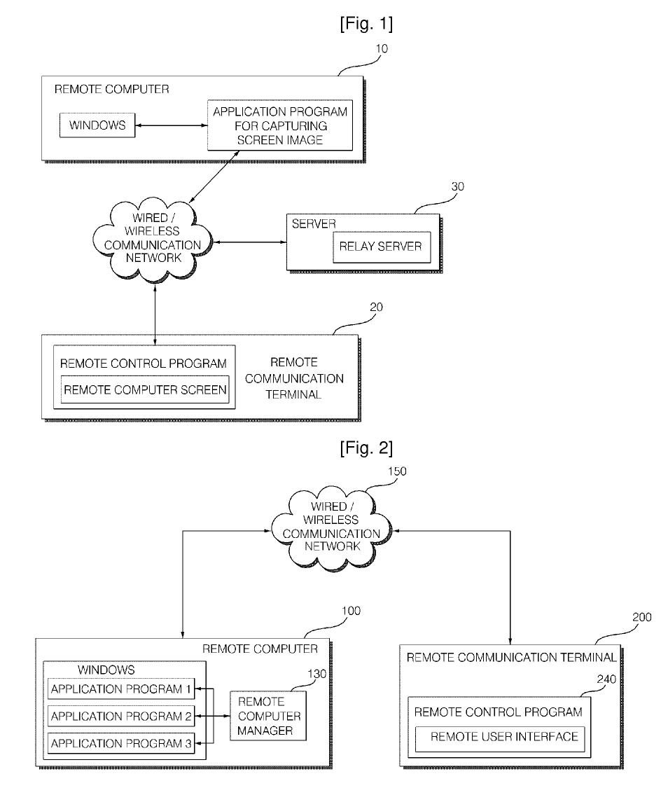

### BEST MODE FOR CARRYING OUT THE INVENTION

Hereinafter, an exemplary embodiment of the present invention will be described in detail with reference to the accompanying drawings.

FIG. 2 is a block diagram illustrating a system employing a method of controlling a remote computer in accordance with an exemplary embodiment of the present invention. Referring to FIG. 2, a remote computer 100, a remote communication terminal 200, and a gateway server 300 are communicatably connected through a wired/wireless network 150. A remote computer manager 130 is installed in the remote computer 100, and a remote control program 240 is installed in the remote communication terminal 200.

The wired/wireless network 150 includes a very high-speed wired internet such as a LAN, xDSL, cable, or dedicated line, a high-speed wireless network such as a wireless LAN, a telephone line MODEM, and a low-speed network such as wireless mobile communication. The remote communication terminal 200 includes various types of personal communication terminals that can display a graphic user interface and connect to a network through a wired or wireless link, such as a personal computer, a personal digital assistant (PDA), or a portable phone.

The remote computer manager 130 is installed and operated in the remote computer 100 which is the object to be remotely controlled. That is, the remote computer manager 130 resides at the remote computer 100. The remote computer manager 130 extracts coordinate information such as a size or a location of an application program which is operated within a corresponding window, recognizes the internal management information of the application program from the outside, extracts information such texts or images on programs based on the above information, processes the extracted information, and transmits the processed information to the remote communication terminal 200.

The remote computer manager 130 extracts or changes the window and control information of the application program being operating on the windows. Various methods such as system API, COM, window pattern, or key/mouse simulation may be selectively used according to the type of the control to extract and change the window and control information. If the control cannot read or write the control value of the application program, the memory region of another application program may be used. If the amount of data is huge, it is also possible to partially extract since it may cause the problem of capacity and expression in a low level communication terminal.

A method of controlling a remote computer in the aforementioned system will now be described.

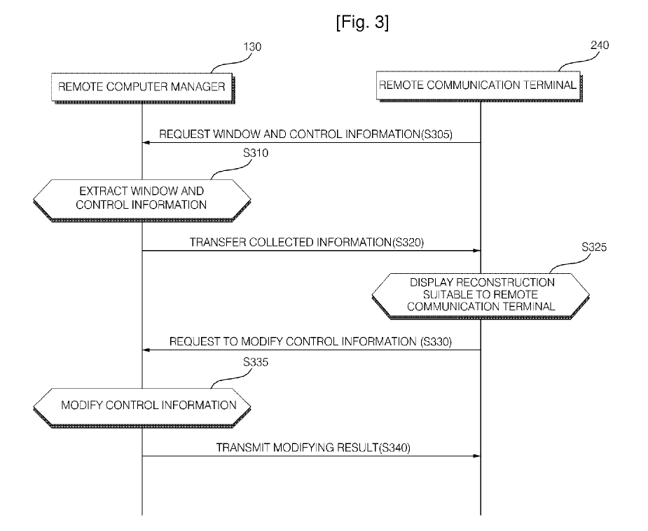

FIG. 3 is a message sequence chart for describing a process of extracting and processing attribute information of an application program of a remote computer. Referring to FIG. 3, a remote communication terminal 200 requests the window and control information of an application program to a remote computer manager 130 of a remote computer 100 in operation S305. According to the request, the remote computer manager 130 extracts the requested window and control information in operation S310, and transmits the extracted and collected information to the remote communication terminal through a wired/wireless network 150 in operation S320. The remote communication terminal 200 reconstructs the transmitted information to fit the size or arrangement information to its screen size and displays the information on the screen in operation S325.

If the remote communication terminal 200 requests to change the control information of the remote computer 100 in operation S330, the remote computer manager 130 changes the corresponding control information in operation S335, and transmits the changing result to the remote communication terminal 200 in operation S5340.

The remote computer 100 and the remote communication terminal 200 may be connected directly or indirectly to each other according to the service mode of providing communication, or may be connected through the gateway server (not shown) in order to manage the difference in environment. The gateway server manages a server connection list of the remote computer manager 130 to manage a session for connecting to the objective remote computer 100 when the control operation is requested by the remote communication terminal 200, and transmits all the data generated during the remote control operation of the remote communication terminal 200 from the remote communication terminal 200 to the remote computer manager 130 or from the remote computer manager 130 to the remote communication terminal 200. Moreover, the gateway server relays all the received data packets without protocol analysis and conversion after the remote communication terminal 200 and the remote computer manager 130 are connected to each other through the proxy session.

The remote communication terminal 200 receives the information regulated in a predetermined format suitable to the remote computer 100 and transforms the regulated information to be suitable to its environment. The remote communication terminal 200 may control the remote computer 100 through a virtual mouse. That is, the virtual mouse cursor similar to that of the remote computer 100 is displayed on the screen of the remote communication terminal 200, and the predetermined buttons of the remote communication terminal 200 are assigned as up, down, left, and right keys, so that the predetermined buttons are controlled like as the mouse moving on the screen of the remote computer 100. Therefore, the operations of selecting, executing, or moving the application program can be performed.

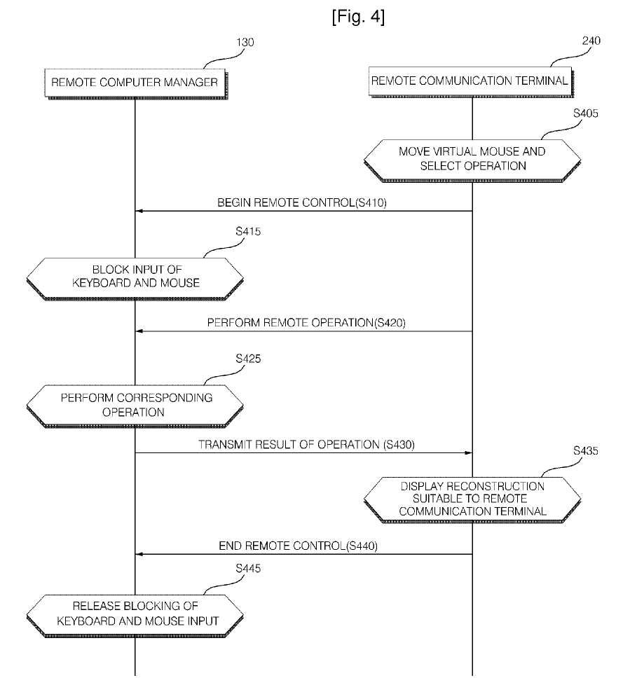

FIG. 4 is a message sequence chart for describing a process of controlling a remote computer with a virtual mouse. Referring to FIG. 4, a remote communication terminal 200 selects a virtual mouse motion and operation in operation S405, and, therefore, remote control begins in operation S410. If the remote communication terminal 200 controls a mouse or a keyboard with a virtual mouse, the keyboard or mouse input operation in a remote computer 100 is blocked in order to prevent the remote control operation of the remote communication terminal 200 to be interrupted by the remote computer 100.

The remote communication terminal 200 performs the remote control operation with the virtual mouse in operation S420. Then, the remote computer manager 130 performs the corresponding operation in operation S425 and transmits the operation performing result to the remote communication terminal 200 in operation S430. The remote communication terminal 200 reconstructs its screen for displaying images and displays the reconstructed screen in operation S5435. Then, the remote communication terminal 200 terminates the remote control operation in operation S440. When the remote control operation is terminated, the remote computer manager 130 releases the blocking of keyboard or mouse input in operation S445.

The user of the remote communication terminal 200 can control the remote computer 100 or performs the functions for arranging or expressing the window of the application program transferred from the remote computer 100 in various ways. One of the ways is to remotely execute a predetermined program. The windows start menu and background screen abbreviated icon information may be brought on the basis of the information transmitted from the remote computer manager 130, or with the virtual mouse. Through this, the objective predetermined application program can be executed through the remote communication terminal 200. Meanwhile, the program that is not registered in the menu may be executed by controlling the window explorer and suchlike.

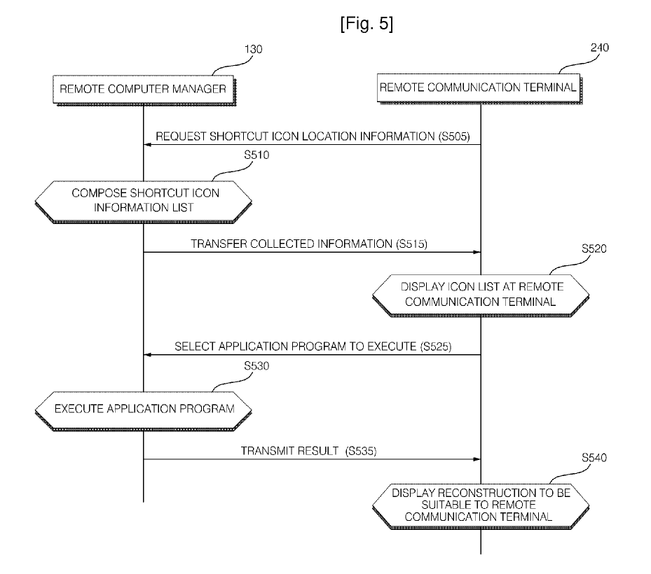

FIG. 5 is a message sequence chart for describing a process of executing an application program of a remote computer with a remote communication terminal. Referring to FIG. 5, when a remote communication terminal 200 requests abbreviated icon location information to a remote computer manager 130 of a remote computer 100, the remote computer manager 130 constructs a abbreviated icon information list in operation S510 and transmits the collected information to the remote communication terminal 200 in operation S515. According to this operation, the remote communication terminal 200 displays the icon list on the screen thereof in operation S520. The remote computer manager 130 executes the requested application program in operation S530, and transmits the result to the remote communication terminal 200 in operation S535. When the program is executed, the screen of the remote communication terminal is reconstructed and displayed through the function of sensing and notifying window information modification in operation S540.

The application program and the screen information displayed on the screen of the remote computer are displayed on the screen of the remote communication terminal 200, and the screen information of the remote computer 100, all the application programs being executing, and window attribute and location information of the application program window are transmitted. The remote communication terminal 200 displays the received information on its screen to be suitable to the screen size in a frame format similar to that of the remote computer 100.

A predetermined application program can be selected from the screen information of the remote computer, which is transmitted from the remote computer and displayed on the screen of the remote communication terminal. A previous or next program can be selected according to the order of the window execution with up, down, left, and right keys, or with the aforementioned virtual mouse.

When the predetermined application program is selected, it is possible to display only the corresponding window on the entire screen of the remote communication terminal 200. The predetermined window control or the menu icon can be selected using directional keys and suchlike within the corresponding window. According to the type of the control, the menu of the remote communication terminal 200 varies. The control panel of the window control is also differently displayed to be suitable to the remote communication terminal 200 according to the control type.

In addition, it is possible to control the above operations by transmitting the virtual mouse event if the operation is not possible on the control panel or if the more convenient operation is required.

Although the entire screen information of the remote computer or the screen of the predetermined application program is displayed on the screen of the remote communication terminal 200, the screen of the remote communication terminal 200 may be too small to read the contents on the screen. In this case, the information may be displayed at the remote communication terminal 200 by enlarging the screen resolution of the remote communication terminal 200 at X times, and the enlarged screen can be displayed on the entire screen of the remote communication terminal 200 to make it easy to perform more detailed information search and control. The contents exceeding the entire screen of the remote communication terminal 200 may be seen by scrolling.

While the present invention has been described with respect to certain preferred embodiments, it will be apparent to those skilled in the art that various changes and modifications may be made without departing from the scope of the invention as defined in the following claims.

### INDUSTRIAL APPLICABILITY

A method and system for controlling a remote computer according to the present invention allows a user to directly control a computer in a remote location using a low performance remote communication terminal in wired/wireless low-speed communication network environment.

1. A method for controlling a remote computer, comprising:
requesting attribute information of an application program installed in the remote computer which is located at a remote location and connected to a communication network;
receiving information through the communication network, wherein the information is created by extracting the attribute information of the application program and processing the extracted attribute information at the remote computer through; and
at a remote communication terminal, reconstructing a user interface of the application program on the basis of the received information.

2. The method of claim 1, wherein the received information comprises at least one of window coordinate information for the application program, graphic user interface (GUI) control information used within the application program, and image capturing information for the application program.

3. The method of claim 2, wherein the image capturing information for the application program is information that is captured only a predetermined portion of an image of the application program if a screen resolution of the remote communication terminal is lower than that of the remote computer.

4. The method of claim 2, wherein the window of the application program is expressed in a frame format.

5. The method of claim 1, further comprising:
requesting to modify the attribute information of the application program; and
at the remote computer, modifying the attribute information of the application program in response to the request and reporting the modified result.

6. The method of claim 1, further comprising: at the remote communication terminal, controlling an input device to be correspondent to an input unit of the remote computer.

7. The method of claim 1, wherein the received information is regulated in a pre-determined format to be correspondent to a transmit rate of the communication network.

8. The method of claim 1, wherein in the reconstructing of the user interface, the received information is expressed by reconstructing coordinates to be correspondent to a screen size of the remote communication terminal.

9. The method of claim 1, further comprising:
receiving icon information of the remote computer and displaying the received icon information at the remote communication terminal; and
driving the application program of the remote computer corresponding to selected icons from the displayed icon information.

10. A system for controlling a remote computer, comprising:
a remote computer manager for extracting and processing attribute information of an application program installed in the remote computer and transmitting the processed information through a communication network; and
a remote communication terminal for requesting the attribute information of the application program and reconstructing a user interface of the application program on the basis of the transmitted information from the remote computer.

11. The system of claim 10, wherein the remote computer manager is included in the remote computer.

12. The system of claim 10, wherein the remote computer and the remote communication terminal communicate with each other directly through the communication network.

13. The system of claim 10, wherein the remote computer and the remote communication terminal communicate with each other through a gateway server.

14. The system of claim 10, wherein the transmitted information from the remote computer manager comprises at least one of window coordinate information for the application program, graphic user interface (GUI) control information used within the application program, and image capturing information for the application program.

15. The system of claim 14, wherein the image capturing information for the application program is information that is captured only a predetermined portion of an image of the application program if a screen resolution of the remote communication terminal is lower than that of the remote computer.

16. The system of claim 10, wherein the information transmitted from the remote computer manager is regulated in a predetermined format to be correspondent to a transmit rate of the communication network.

17. The system of claim 10, further comprising an input device corresponding to an input unit of the remote computer to drive the application program of the remote computer through the user interface.

18. The system of claim 10, wherein the user interface is expressed by reconstructing the received information to be correspondent to a screen size of the remote communication terminal.
